(19) United States
(12) Patent Application Publication
(10) Pub. No.: US 2010/0118942 A1
(43) Pub. Date: May 13, 2010

(54) METHODS AND APPARATUS AT AN ENCODER AND DECODER FOR SUPPORTING SINGLE LOOP DECODING OF MULTI-VIEW CODED VIDEO

(75) Inventors: Purvin Bibhas Pandit, Franklin Park, NJ (US); Peng Yin, Plainsboro, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/452,054

(22) PCT Filed: Jun. 24, 2008
(86) PCT No.: PCT/US08/07894

§ 371 Date: Dec. 14, 2009

Related U.S. Application Data
(60) Provisional application No. 60/946,932, filed on Jun. 28, 2007.

(51) Int. Cl. H04N 7/32

(52) U.S. Cl. 375/240.12; 375/E07.243

(57) ABSTRACT

There are provided methods and apparatus at an encoder and decoder for supporting single loop decoding of multi-view coded video. An apparatus includes an encoder for encoding multi-view video content to enable single loop decoding of the multi-view video content when the multi-view video content is encoded using inter-view prediction. Similarly, a method is also described for encoding multi-view video content to support single loop decoding of the multi-view video content when the multi-view video content is encoded using inter-view prediction. Corresponding decoder apparatus and method are also described.

### CROSS-REFERENCE TO RELATED APPLICATIONS

This application claims the benefit of U.S. Provisional Application Ser. No. 60/946,932, filed Jun. 28, 2007, which is incorporated by reference herein in its entirety. Further, this application is related to the non-provisional application, Attorney Docket No. PU080067, entitled “METHODS AND APPARATUS AT AN ENCODER AND DECODER FOR SUPPORTING SINGLE LOOP DECODING OF MULTI-VIEW CODED VIDEO”, which is commonly assigned, incorporated by reference herein, and concurrently filed herewith.

### TECHNICAL FIELD

The present principles relate generally to video encoding and decoding and, more particularly, to methods and apparatus at an encoder and decoder for supporting single loop decoding of multi-view coded video.

### BACKGROUND

Multi-view video coding (MVC) serves a wide variety of applications, including free-viewpoint and three dimensional (3D) video applications, home entertainment, and surveillance. In those multi-view applications, the amount of video data involved is enormous.

Since a multi-view video source includes multiple views of the same or similar scene, there exists a high degree of correlation between the multiple view images. Therefore, view redundancy can be exploited in addition to temporal redundancy and is achieved by performing view prediction across the different views of the same or similar scene.

In a first prior art approach, motion skip mode is proposed to improve the coding efficiency for MVC. The first prior art approach originated from the idea that there is a similarity with respect to the motion between two neighboring views.

Motion Skip Mode infers the motion information, such as macroblock type, motion vector, and reference indices, directly from the corresponding macroblock in the neighboring view at the same temporal instant. The method is decomposed into the two following stages: (1) search for the corresponding macroblock; and (2) derivation of motion information. In the first stage, a global disparity vector (GDV) is used to indicate the corresponding position (macroblock) in the picture of the neighboring view. The global disparity vector is measured by the macroblock-size of units between the current picture and the picture of the neighboring view. The global disparity vector can be estimated and decoded periodically such as, for example, at every anchor picture. In such a case, the global disparity vector of a non-anchor picture is interpolated using the recent global disparity vectors from an anchor picture. In the second stage, motion information is derived from the corresponding macroblock in the picture of the neighboring view, and the motion information is applied to the current macroblock. Motion skip mode is disabled in the case when the current macroblock is in the picture of the base view or in an anchor picture which is defined in the joint multi-view video model (JMVM), since the proposed method of the first prior art approach exploits the picture from the neighboring view to present another way for the inter prediction process.

To notify a decoder of the use of motion skip mode, a motion_skip_flag is included in the head of a macroblock layer syntax element for multi-view video coding. If motion_skip_flag is enabled, the current macroblock derives macroblock type, motion vector, and reference indices from the corresponding macroblock in the neighboring view.

However, in a practical scenario, multi-view video systems involving a large number of cameras will be built using heterogeneous cameras, or cameras that have not been perfectly calibrated. With so many cameras, the memory requirement of the decoder as well as the complexity can significantly increase. In addition, certain applications may only require decoding some of the views from a set of views. As a result, it might not be necessary to completely reconstruct the views that are not needed for output.

### SUMMARY

These and other drawbacks and disadvantages of the prior art are addressed by the present principles, which are directed to methods and apparatus at an encoder and decoder for supporting single loop decoding of multi-view coded video.

According to an aspect of the present principles, there is provided an apparatus. The apparatus includes an encoder for encoding multi-view video content to enable single loop decoding of the multi-view video content when the multi-view video content is encoded using inter-view prediction.

According to another aspect of the present principles, there is provided a method. The method includes encoding multi-view video content to support single loop decoding of the multi-view video content when the multi-view video content is encoded using inter-view prediction.

According to still another aspect of the present principles, there is provided an apparatus. The apparatus includes a decoder for decoding multi-view video content using single loop decoding when the multi-view video content is encoded using inter-view prediction.

According to a further aspect of the present principles, there is provided a method. The method includes decoding multi-view video content using single loop decoding when the multi-view video content is encoded using inter-view prediction.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) encoder to which the present principles may be applied, in accordance with an embodiment of the present principles;

FIG. 2 is a block diagram for an exemplary Multi-view Video Coding (MVC) decoder to which the present principles may be applied, in accordance with an embodiment of the present principles;

FIG. 3 is a diagram for a coding structure for an exemplary MVC system with 8 views to which the present principles may be applied, in accordance with an embodiment of the present principles;

FIG. 4 is a flow diagram for an exemplary method for encoding multi-view video content in support of single loop decoding, in accordance with an embodiment of the present principles;

FIG. 5 is a flow diagram for an exemplary method for single loop decoding of multi-view video content, in accordance with an embodiment of the present principles;

FIG. 6 is a flow diagram for another exemplary method for encoding multi-view video content in support of single loop decoding, in accordance with an embodiment of the present principles; and

FIG. 7 is a flow diagram for another exemplary method for single loop decoding of multi-view video content, in accordance with an embodiment of the present principles.

### DETAILED DESCRIPTION

The present principles are directed to methods and apparatus at an encoder and decoder for supporting single loop decoding of multi-view coded video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment. Moreover, the phrase “in another embodiment” does not exclude the subject matter of the described embodiment from being combined, in whole or in part, with another embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As used herein, a “multi-view video sequence” refers to a set of two or more video sequences that capture the same scene from different view points.

Further, as interchangeably used herein, “cross-view” and “inter-view” both refer to pictures that belong to a view other than a current view.

Additionally, as used herein, the phrase “without a complete reconstruction” refers to the case when motion compensation is not performed in the encoding or decoding loop.

Moreover, it is to be appreciated that while the present principles are described herein with respect to the multi-view video coding extension of the MPEG-4 AVC standard, the present principles are not limited to solely this standard and corresponding extension and, thus, may be utilized with respect to other video coding standards, recommendations, and extensions thereof relating to multi-view video coding, while maintaining the spirit of the present principles.

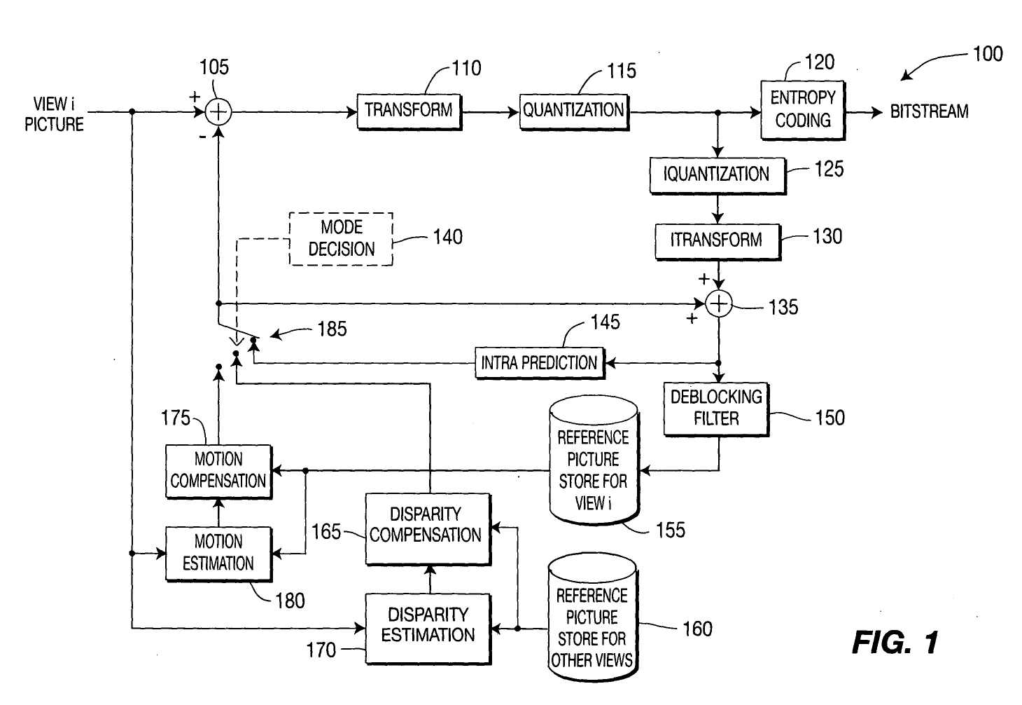

Turning to FIG. 1, an exemplary Multi-view Video Coding (MVC) encoder is indicated generally by the reference numeral 100. The encoder 100 includes a combiner 105 having an output connected in signal communication with an input of a transformer 110. An output of the transformer 110 is connected in signal communication with an input of quantizer 115. An output of the quantizer 115 is connected in signal communication with an input of an entropy coder 120 and an input of an inverse quantizer 125. An output of the inverse quantizer 125 is connected in signal communication with an input of an inverse transformer 130. An output of the inverse transformer 130 is connected in signal communication with a first non-inverting input of a combiner 135. An output of the combiner 135 is connected in signal communication with an input of an intra predictor 145 and an input of a deblocking filter 150. An output of the deblocking filter 150 is connected in signal communication with an input of a reference picture store 155 (for view i). An output of the reference picture store 155 is connected in signal communication with a first input of a motion compensator 175 and a first input of a motion estimator 180. An output of the motion estimator 180 is connected in signal communication with a second input of the motion compensator 175

An output of a reference picture store 160 (for other views) is connected in signal communication with a first input of a disparity/illumination estimator 170 and a first input of a disparity/illumination compensator 165. An output of the disparity/illumination estimator 170 is connected in signal communication with a second input of the disparity/illumination compensator 165.

An output of the entropy decoder 120 is available as an output of the encoder 100. A non-inverting input of the combiner 105 is available as an input of the encoder 100, and is connected in signal communication with a second input of the disparity/illumination estimator 170, and a second input of the motion estimator 180. An output of a switch 185 is connected in signal communication with a second non-inverting input of the combiner 135 and with an inverting input of the combiner 105. The switch 185 includes a first input connected in signal communication with an output of the motion compensator 175, a second input connected in signal communication with an output of the disparity/illumination compensator 165, and a third input connected in signal communication with an output of the intra predictor 145.

A mode decision module 140 has an output connected to the switch 185 for controlling which input is selected by the switch 185.

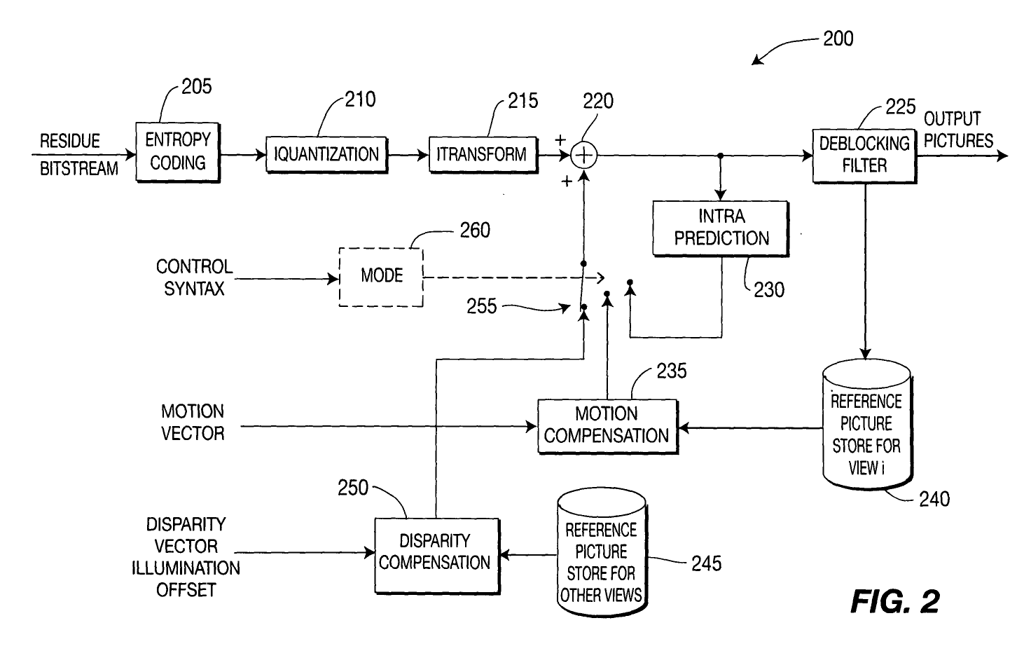

Turning to FIG. 2, an exemplary Multi-view Video Coding (MVC) decoder is indicated generally by the reference numeral 200. The decoder 200 includes an entropy decoder 205 having an output connected in signal communication with an input of an inverse quantizer 210. An output of the inverse quantizer is connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225 and an input of an intra predictor 230. An output of the deblocking filter 225 is connected in signal communication with an input of a reference picture store 240 (for view i). An output of the reference picture store 240 is connected in signal communication with a first input of a motion compensator 235.

An output of a reference picture store 245 (for other views) is connected in signal communication with a first input of a disparity/illumination compensator 250.

An input of the entropy coder 205 is available as an input to the decoder 200, for receiving a residue bitstream. Moreover, an input of a mode module 260 is also available as an input to the decoder 200, for receiving control syntax to control which input is selected by the switch 255. Further, a second input of the motion compensator 235 is available as an input of the decoder 200, for receiving motion vectors. Also, a second input of the disparity/illumination compensator 250 is available as an input to the decoder 200, for receiving disparity vectors and illumination compensation syntax.

An output of a switch 255 is connected in signal communication with a second non-inverting input of the combiner 220. A first input of the switch 255 is connected in signal communication with an output of the disparity/illumination compensator 250. A second input of the switch 255 is connected in signal communication with an output of the motion compensator 235. A third input of the switch 255 is connected in signal communication with an output of the intra predictor 230. An output of the mode module 260 is connected in signal communication with the switch 255 for controlling which input is selected by the switch 255. An output of the deblocking filter 225 is available as an output of the decoder.

As noted above, the present principles are directed to methods and apparatus at an encoder and decoder for supporting single loop decoding of multi-view coded video.

The present principles are particularly suited to the cases when only certain views of multi-view video content are to be decoded. Such applications do not involve reconstructing the reference view completely (i.e., pixel data). In an embodiment, certain elements from those views can be inferred and used for other views, thus saving memory and time.

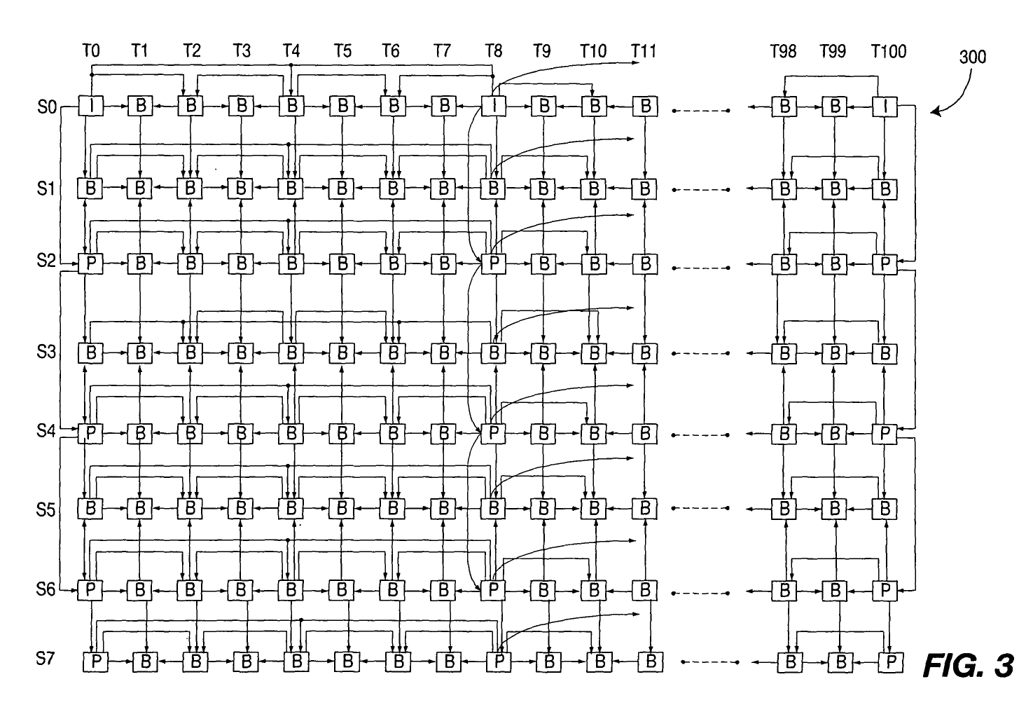

The current multi-view video coding specification requires that all the views be reconstructed completely. Reconstructed views can then be used as inter-view references. Turning to FIG. 3, a coding structure for an exemplary MVC system with 8 views is indicated generally by the reference numeral 300.

As a result of the fact that reconstructed views can be used as inter-view references, each view must be completely decoded and stored in memory even though the respective view may not be output. This is not very efficient in terms of memory and processor utilization since you would need to spend processor time to decode such non-outputted views, as well as memory to store decoded pictures for such non-outputted views.

Thus, in accordance with the present principles, we propose methods and apparatus for supporting single loop decoding for a multi-view coded sequence. As noted above, while the examples provide herein are primarily described with respect to the multi-view video coding extension of the MPEG-4 AVC Standard, given the teachings of the present principles provided herein, it is readily appreciated that the present principles may be readily applied to any multi-view video coding system by one of ordinary skill in this and related arts, while maintaining the spirit of the present principles.

In one embodiment of single loop decoding, only the anchor pictures will use completely reconstructed pictures as references while the non-anchor pictures do not use completely reconstructed pictures as references. In order to improve the coding efficiency for the non-anchor pictures, we propose that the inter-view prediction be used such that the inter-view prediction infers certain data from the neighboring views without the need to completely reconstruct the neighboring views. The neighboring reference views are indicated by the sequence parameter set syntax shown in TABLE 1. TABLE 1 shows the sequence parameter set (SPS) syntax for the multi-view video coding extension of the MPEG-4 AVC Standard, in accordance with an embodiment of the present principles.

TABLE 1

| | | De- |
|---|---|---|
| seq_parameter_set_mvc_extension( ) { | C | scriptor |
| num_views_minus_1 | | ue(v) |
| for(i = 0; i <= num_views_minus_1; i++) | | |
| view_id[i] | | ue(v) |
| for(i = 0; i <= num_views_minus_1; i++) { | | |
| num_anchor_refs_l0[i] | | ue(v) |
| for( j = 0; j < num_anchor_refs_l0[i]; j++ ) | | |
| anchor_ref_l0[i][j] | | ue(v) |
| num_anchor_refs_l1[i] | | ue(v) |
| for( j = 0; j < num_anchor_refs_l1[i]; j++ ) | | |
| anchor_ref_l1[i][j] | | ue(v) |
| } | | |
| for(i = 0; i <= num_views_minus_1; i++) { | | |
| num_non_anchor_refs_l0[i] | | ue(v) |
| for( j = 0; j < num_non_anchor_refs_l0[i]; j++ ) | | |
| non_anchor_ref_l0[i][j] | | ue(v) |
| num_non_anchor_refs_l1[i] | | ue(v) |
| for( j = 0; j < num_non_anchor_refs_l1[i]; j++ ) | | |
| non_anchor_ref_l1[i][j] | | ue(v) |
| } | | |
| } | | |

The information that can be inferred from the neighboring reference views without complete reconstruction can be a combination of one or more of the following: (1) motion and mode information; (2) residual prediction; (3) intra prediction modes; (4) illumination compensation offset; (5) depth information; and (6) deblocking strength. It is to be appreciated that the preceding types of information are merely illustrative and the present principles are not limited to solely the preceding types of information with respect to information that can be inferred from the neighboring views without complete reconstruction. For example, it is to be appreciated that any type of information relating to characteristics of at least a portion of the pictures from the neighboring views, including any type of information relating to encoding and/or decoding such pictures or picture portions may be used in accordance with the present principles, while maintaining the spirit of the present principles. Moreover, such information may be inferred from syntax and/or other sources, while maintaining the spirit of the present principles.

Regarding the motion and mode information, this is similar to the motion skip mode in the current multi-view video coding specification where the motion vectors, mode, and reference index information is inferred from a neighboring view. Additionally, the motion information inferred can be refined by sending additional data. Moreover, the disparity information can also be inferred.

Regarding the residual prediction, here the residual data from the neighboring view is used as prediction data for the residue for the current macroblock. This residual data can further be refined by sending additional data for the current macroblock.

Regarding the intra prediction modes, such modes can also be inferred. Either the reconstructed intra macroblocks can be used directly as prediction data or the intra prediction modes can be used directly for the current macroblock.

Regarding the illumination compensation offset, the illumination compensation offset value can be inferred and also further refined.

Regarding the depth information, the depth information can also be inferred.

In order to determine whether a multi-view video coded sequence supports single loop decoding, high level syntax can be present at one or more of the following: sequence parameter set (SPS); picture parameter set (PPS); network abstraction layer (NAL) unit header; slice header; and Supplemental Enhancement Information (SEI) message. Single loop multi-view video decoding can also be specified as a profile.

TABLE 2 shows proposed sequence parameter set (SPS) syntax for the multi-view video coding extension of the MPEG-4 AVC Standard, including a non_anchor_single_loop_decoding_flag syntax element, in accordance with an embodiment. The non_anchor_single_loop_decoding_flag is an additional syntax element added in the loop that signals the non-anchor picture references. The non_anchor_single_loop_decoding_flag syntax element is added to signal whether the references for the non-anchor pictures of a view “i” should be completely decoded to decode the view “i” or not. The non_anchor_single_loop_decoding_flag syntax element has the following semantics:

non_anchor_single_loop_decoding_flag[i] equal to 1 indicates that the reference views for the non-anchor pictures of the view with view id equal to view_id[i] need not be completely reconstructed to decode the view. non_anchor_single_loop_decoding_flag[i] equal to 0 indicates that the reference views for the non-anchor pictures of the view with view id equal to view_id[i] should be completely reconstructed to decode the view.

TABLE 2

| | | De- |
|---|---|---|
| seq_parameter_set_mvc_extension( ) { | C | scriptor |
| num_views_minus_1 | | ue(v) |
| for(i = 0; i <= num_views_minus_1; i++) | | |
| view_id[i] | | ue(v) |
| for(i = 0; i <= num_views_minus_1; i++) { | | |
| num_anchor_refs_l0[i] | | ue(v) |
| for( j = 0; j < num_anchor_refs_l0[i]; j++ ) | | |
| anchor_ref_l0[i][j] | | ue(v) |
| num_anchor_refs_l1[i] | | ue(v) |
| for( j = 0; j < num_anchor_refs_l1[i]; j++ ) | | |
| anchor_ref_l1[i][j] | | ue(v) |
| } | | |
| for(i = 0; i <= num_views_minus_1; i++) { | | |
| num_non_anchor_refs_l0[i] | | ue(v) |
| non_anchor_single_loop_decoding_flag[i] | | ue(v) |
| for( j = 0; j < num_non_anchor_refs_l0[i]; j++ ) | | |
| non_anchor_ref_l0[i][j] | | ue(v) |
| num_non_anchor_refs_l1[i] | | ue(v) |
| for( j = 0; j < num_non_anchor_refs_l1[i]; j++ ) | | |
| non_anchor_ref_l1[i][j] | | ue(v) |
| } | | |
| } | | |

TABLE 3 shows proposed sequence parameter set (SPS) syntax for the multi-view video coding extension of the MPEG-4 AVC Standard, including a non_anchor_single_loop_decoding_flag syntax element, in accordance with another embodiment. The non_anchor_single_loop_decoding_flag syntax element is used to indicate that, for the whole sequence, all the non-anchor pictures can be decoded without fully reconstructing the reference views. The non_anchor_single_loop_decoding_flag syntax element has the following semantics:

non_anchor_single_loop_decoding_flag equal to 1 indicates that all the non-anchor pictures of all the views can be decoded without fully reconstructing the pictures of the corresponding reference views.

TABLE 3

| | | De- |
|---|---|---|
| seq_parameter_set_mvc_extension( ) { | C | scriptor |
| num_views_minus_1 | | ue(v) |
| non_anchor_single_loop_decoding_flag | | u(1) |
| for(i = 0; i <= num_views_minus_1; i++) | | |
| view_id[i] | | ue(v) |
| for(i = 0; i <= num_views_minus_1; i++) { | | |
| num_anchor_refs_l0[i] | | ue(v) |
| for( j = 0; j < num_anchor_refs_l0[i]; j++ ) | | |
| anchor_ref_l0[i][j] | | ue(v) |
| num_anchor_refs_l1[i] | | ue(v) |
| for( j = 0; j < num_anchor_refs_l1[i]; j++ ) | | |
| anchor_ref_l1[i][j] | | ue(v) |
| } | | |
| for(i = 0; i <= num_views_minus_1; i++) { | | |
| num_non_anchor_refs_l0[i] | | ue(v) |
| for( j = 0; j < num_non_anchor_refs_l0[i]; j++ ) | | |
| non_anchor_ref_l0[i][j] | | ue(v) |
| num_non_anchor_refs_l1[i] | | ue(v) |
| for( j = 0; j < num_non_anchor_refs_l1[i]; j++ ) | | |
| non_anchor_ref_l1[i][j] | | ue(v) |
| } | | |
| } | | |

In another embodiment of single loop decoding, even the anchor pictures are enabled with respect to single loop decoding. TABLE 4 shows proposed sequence parameter set (SPS) syntax for the multi-view video coding extension of the MPEG-4 AVC Standard, including an anchor_single_loop_decoding_flag syntax element, in accordance with another embodiment. The anchor_single_loop_decoding_flag syntax element can be present for the anchor picture dependency loop in the sequence parameter set. The anchor_single_loop_decoding_flag syntax element has the following semantics:

anchor_single_loop_decoding_flag[i] equal to 1 indicates that the reference views for the anchor pictures of the view with view id equal to view_id[i] need not be completely reconstructed to decode the view. anchor_single_loop_decoding_flag[i] equal to 0 indicates that the reference views for the anchor pictures of the view with view id equal to view_id[i] should be completely reconstructed to decode the view.

TABLE 4

| | | De- |
|---|---|---|
| seq_parameter_set_mvc_extension( ) { | C | scriptor |
| num_views_minus_1 | | ue(v) |
| for(i = 0; i <= num_views_minus_1; i++) | | |
| view_id[i] | | ue(v) |
| for(i = 0; i <= num_views_minus_1; i++) { | | |
| num_anchor_refs_l0[i] | | ue(v) |
| anchor_single_loop_decoding_flag[i] | | u(1) |
| for( j = 0; j < num_anchor_refs_l0[i]; j++ ) | | |
| anchor_ref_l0[i][j] | | ue(v) |
| num_anchor_refs_l1[i] | | ue(v) |
| for( j = 0; j < num_anchor_refs_l1[i]; j++ ) | | |
| anchor_ref_l1[i][j] | | ue(v) |
| } | | |
| for(i = 0; i <= num_views_minus_1; i++) { | | |
| num_non_anchor_refs_l0[i] | | ue(v) |
| non_anchor_single_loop_decoding_flag[i] | | u(1) |
| for( j = 0; j < num_non_anchor_refs_l0[i]; j++ ) | | |
| non_anchor_ref_l0[i][j] | | ue(v) |
| num_non_anchor_refs_l1[i] | | ue(v) |
| for( j = 0; j < num_non_anchor_refs_l1[i]; j++ ) | | |
| non_anchor_ref_l1[i][j] | | ue(v) |
| } | | |
| } | | |

TABLE 5 shows proposed sequence parameter set (SPS) syntax for the multi-view video coding extension of the MPEG-4 AVC Standard, including an anchor_single_loop_decoding_flag syntax element, in accordance with another embodiment. The anchor_single_loop_decoding_flag syntax element has the following semantics:

anchor_single_loop_decoding_flag equal to 1 indicates that all the anchor pictures of all the views can be decoded without fully reconstructing the pictures of the corresponding reference views.

TABLE 5

| | | De- |
|---|---|---|
| seq_parameter_set_mvc_extension( ) { | C | scriptor |
| num_views_minus_1 | | ue(v) |
| anchor_single_loop_decoding_flag | | u(1) |
| non_anchor_single_loop_decoding_flag | | u(1) |
| for(i = 0; i <= num_views_minus_1; i++) | | |
| view_id[i] | | ue(v) |
| for(i = 0; i <= num_views_minus_1; i++) { | | |
| num_anchor_refs_l0[i] | | ue(v) |
| for( j = 0; j < num_anchor_refs_l0[i]; j++ ) | | |
| anchor_ref_l0[i][j] | | ue(v) |
| num_anchor_refs_l1[i] | | ue(v) |
| for( j = 0; j < num_anchor_refs_l1[i]; j++ ) | | |
| anchor_ref_l1[i][j] | | ue(v) |
| } | | |
| for(i = 0; i <= num_views_minus_1; i++) { | | |
| num_non_anchor_refs_l0[i] | | ue(v) |
| for( j = 0; j < num_non_anchor_refs_l0[i]; j++ ) | | |
| non_anchor_ref_l0[i][j] | | ue(v) |
| num_non_anchor_refs_l1[i] | | ue(v) |
| for( j = 0; j < num_non_anchor_refs_l1[i]; j++ ) | | |
| non_anchor_ref_l1[i][j] | | ue(v) |
| } | | |
| } | | |

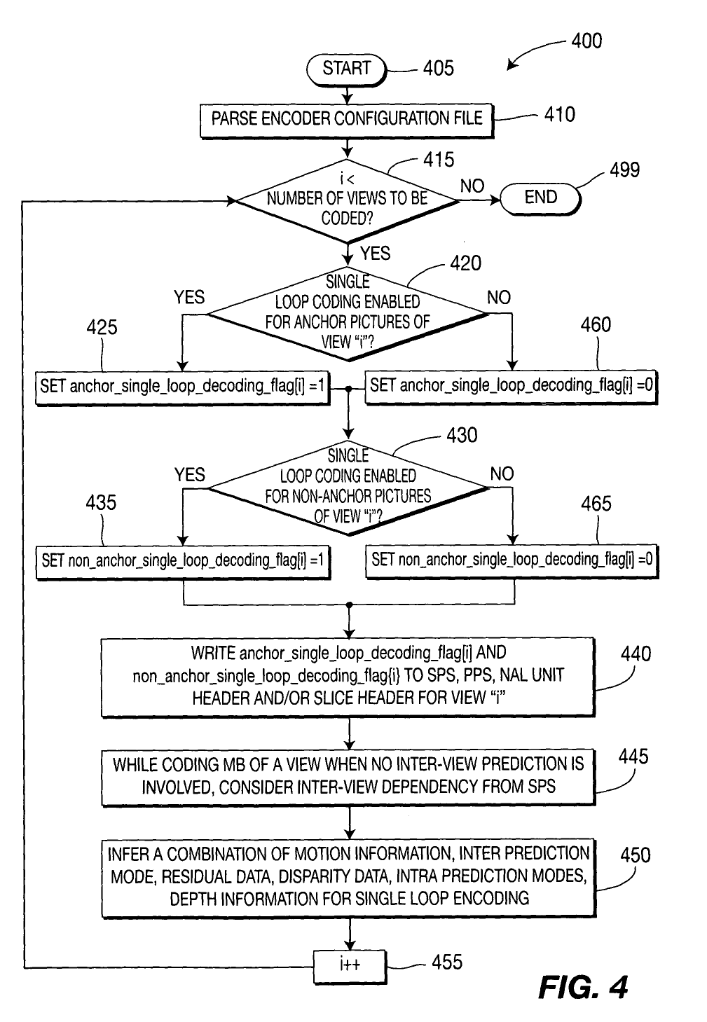

Turning to FIG. 4, an exemplary method for encoding multi-view video content in support of single loop decoding is indicated generally by the reference numeral 400.

The method 400 includes a start block 405 that passes control to a function block 410. The function block 410 parses the encoder configuration file, and passes control to a decision block 415. The decision block 415 determines whether or not a variable i is less than the number of views to be coded. If so, then control is passed to a decision block 420. Otherwise, control is passed to an end block 499.

The decision block 420 determines whether or not single loop coding is enabled for anchor pictures of view i. If so, then control is passed to a function block 425. Otherwise, control is passed to a function block 460.

The function block 425 sets anchor_single_loop_decoding_flag[i] equal to one, and passes control to a decision block 430. The decision block 430 determines whether or not single loop coding is enabled for non-anchor pictures of view i. If so, then control is passed to a function block 435. Otherwise, control is passed to a function block 465.

The function block 435 sets non_anchor_single_loop_decoding_flag[i] equal to one, and passes control to a function block 440.

The function block 440 writes anchor_single_loop_decoding_flag[i] and non_anchor_single_loop_decoding_flag[i] to sequence parameter set (SPS), picture parameter set (PPS), network abstraction layer (NAL) unit header and/or slice header for view i, and passes control to a function block 445. The function block 445 considers the inter-view dependency from the SPS while coding a macroblock of a view when no inter-prediction is involved, and passes control to a function block 450. The function block 450 infers a combination of motion information, inter prediction mode, residual data, disparity data, intra prediction modes, and depth information for single loop encoding, and passes control to a function block 455. The function block 455 increments the variable i by one, and returns control to the decision block 415. The function block 460 sets anchor_single_loop_decoding_flag[i] equal to zero, and passes control to the decision block 430.

The function block 465 sets non_anchor_single_loop_decoding_flag[i] equal to zero, and passes control to the function block 440.

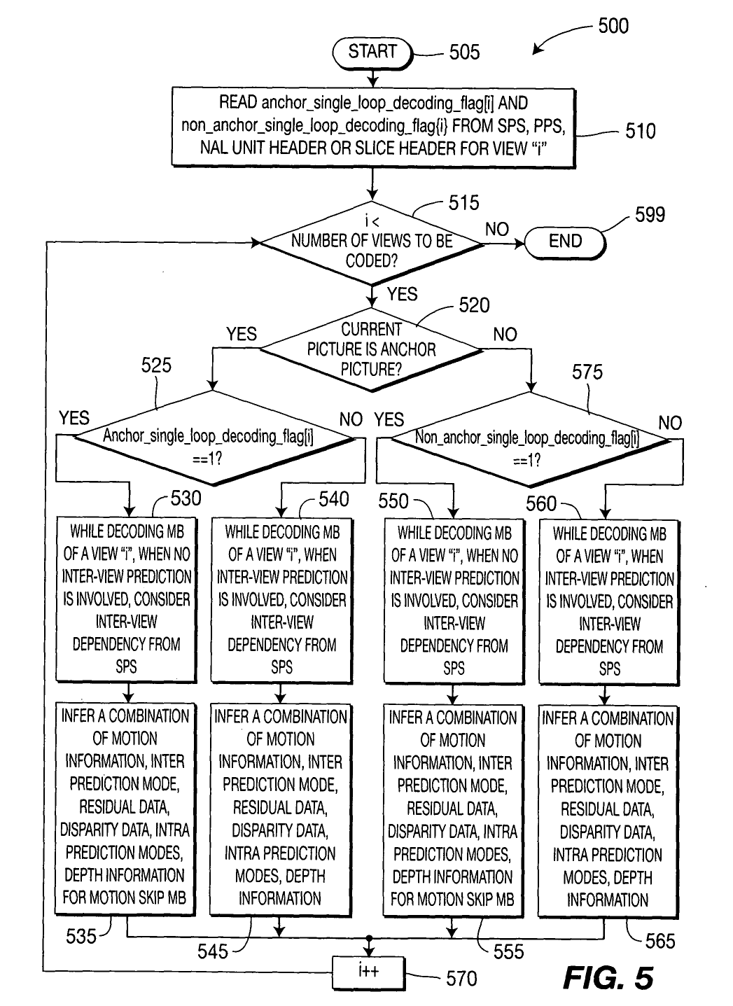

Turning to FIG. 5, an exemplary method for single loop decoding of multi-view video content is indicated generally the reference numeral 500.

The method 500 includes a start block 505 that passes control to a function block 510. The function block 510 reads anchor_single_loop_decoding_flag[i] and non_anchor_single_loop_decoding_flag[i] from the sequence parameter set (SPS), picture parameter set (PPS), network abstraction layer (NAL) unit header, or slice header for view i, and passes control to a decision block 515. The decision block 515 determines whether or not a variable i is less than a number of views to be decoded. If so, the control is passed to a decision block 520. Otherwise, control is passed to an end block 599.

The decision block 520 determines whether or not the current picture is an anchor picture. If so, the control is passed to a decision block 525. Otherwise, control is passed to a decision block 575.

The decision block 525 determines whether or not anchor_single_loop_decoding_flag[i] is equal to one. If so, the control is passed to a function block 530. Otherwise, control is passed to a function block 540.

The function block 530 considers inter-view dependency from the sequence parameter set (SPS) when decoding a macroblock of view i when no inter-prediction is involved, and passes control to a function block 535. The function block 535 infers a combination of motion information, inter prediction mode, residual data, disparity data, intra prediction modes, depth information for motion skip macroblocks, and passes control to a function block 570.

The function block 570 increments the variable i by one, and returns control to the decision block 515.

The function block 540 considers inter-view dependency from the sequence parameter set (SPS) while decoding a macroblock of a view i when inter-prediction is involved, and passes control to a function block 545. The function block 545 infers a combination of motion information, inter-prediction mode, residual data, disparity data, intra prediction modes, and depth information, and passes control to the function block 570.

The decision block 575 determines whether or not non-anchor_single_loop_decoding[i] is equal to one. If so, then control is passed to a function block 550. Otherwise, control is passed to a function block 560.

The function block 550 considers inter-view dependency from the sequence parameter set (SPS) while decoding a macroblock of view i when no inter-view prediction is involved, and passes control to a function block 555. The function 555 infers a combination of motion information, inter prediction mode, residual data, disparity data, intra prediction modes, and depth information for motion skip macroblocks, and passes control to the function block 570.

The function block 560 considers inter-view dependency from the sequence parameter set (SPS) while decoding a macroblock of view i when inter-prediction is involved, and passes control to a function block 565. The function block 565 infers a combination of motion information, inter prediction mode, residual data, disparity data, intra prediction modes, and depth information, and passes control to the function block 570.

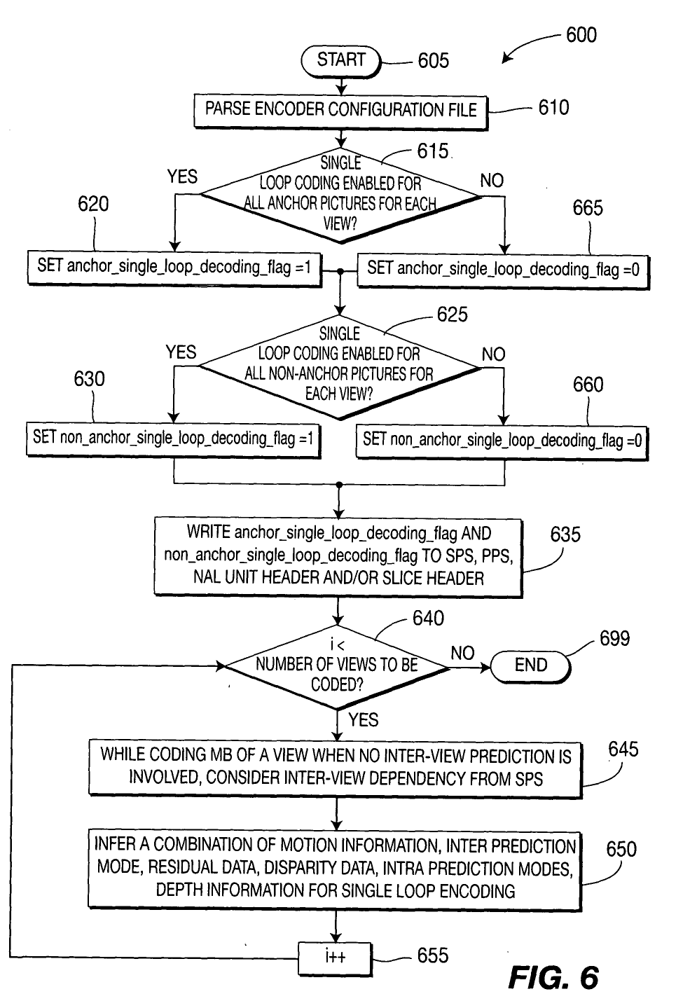

Turning to FIG. 6, another exemplary method for encoding multi-view video content in support of single loop decoding is indicated generally by the reference numeral 600.

The method 600 includes a start block 605 that passes control to a function block 610. The function block 610 parses the encoder configuration file, and passes control to a decision block 615. The decision block 615 determines whether or not single loop coding is enabled for all anchor pictures for each view. If so, then control is passed to a function block 620. Otherwise, control is passed to a function block 665.

The function block 620 sets anchor_single_loop_decoding_flag equal to one, and passes control to a decision block 625. The decision block 625 determines whether or not single loop coding is enabled for all non-anchor pictures for each view. If so, the control is passed to a function block 630. Otherwise, control is passed to a function block 660.

The function block 630 sets non_anchor_single_loop_decoding_flag equal to one, and passes control to a function block 635. The function block 635 writes anchor_single_loop_decoding_flag to the sequence parameter set (SPS), picture parameter set (PPS), network abstraction layer (NAL) unit header and/or slice header, and passes control to a decision block 640. The decision block 640 determines whether or not a variable i is less than the number of views to be coded. If so, then control is passed to a function block 645. Otherwise, control is passed to an end block 699.

The function block 645 considers the inter-view dependency from the SPS while coding a macroblock of a view when no inter-view prediction is involved, and passes control to a function block 650. The function block 650 infers a combination of motion information, inter prediction mode, residual data, disparity data, intra prediction modes, depth information for single loop encoding, and passes control to a function block 655. The function block 655 increments a variable i by one, and returns control to the decision block 640.

The function block 665 sets anchor_single_loop_decoding_flag equal to zero, and passes control to the decision block 625.

The function block 660 sets non_anchor_single_loop_decoding_flag equal to zero, and passes control to the function block 635.

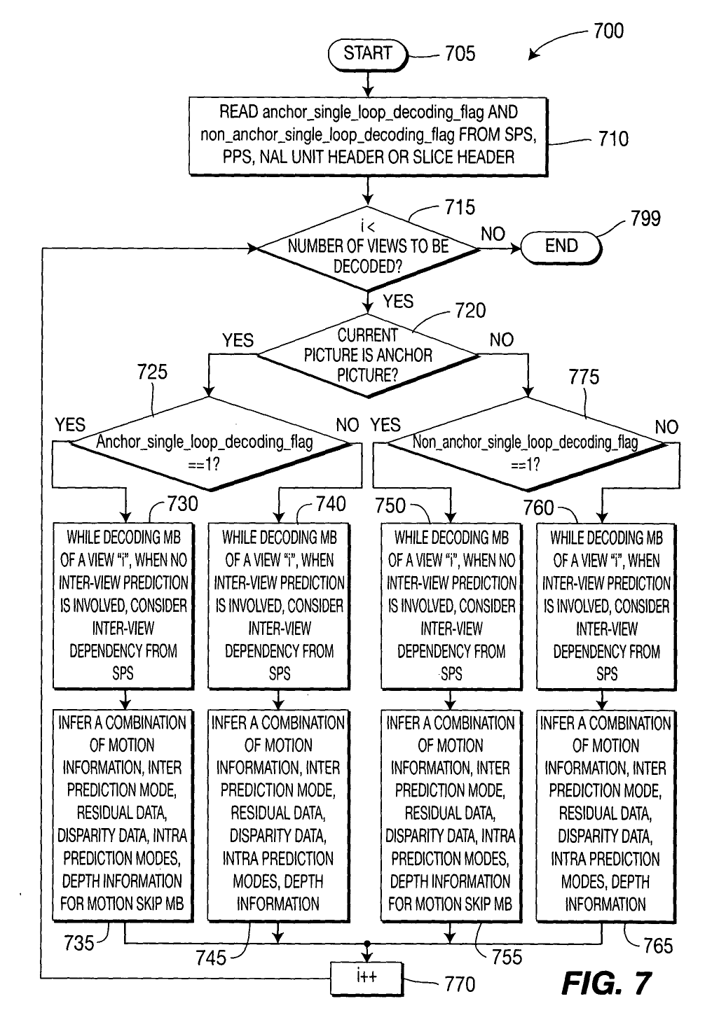

Turning to FIG. 7, another exemplary method for single loop decoding of multi-view video content is indicated generally the reference numeral 700.

The method 700 includes a start block 705 that passes control to a function block 710. The function block 710 reads anchor_single_loop_decoding_flag and non_anchor_single_loop_decoding_flag from the sequence parameter set (SPS), picture parameter set (PPS), network abstraction layer (NAL) unit header, or slice header for view i, and passes control to a decision block 715. The decision block 715 determines whether or not a variable i is less than a number of views to be decoded. If so, the control is passed to a decision block 720. Otherwise, control is passed to an end block 799.

The decision block 720 determines whether or not the current picture is an anchor picture. If so, the control is passed to a decision block 725. Otherwise, control is passed to a decision block 775.

The decision block 725 determines whether or not anchor_single_loop_decoding_flag is equal to one. If so, the control is passed to a function block 730. Otherwise, control is passed to a function block 740.

The function block 730 considers inter-view dependency from the sequence parameter set (SPS) when decoding a macroblock of view i when no inter-prediction is involved, and passes control to a function block 735. The function block 735 infers a combination of motion information, inter prediction mode, residual data, disparity data, intra prediction modes, depth information for motion skip macroblocks, and passes control to a function block 770.

The function block 770 increments the variable i by one, and returns control to the decision block 715.

The function block 740 considers inter-view dependency from the sequence parameter set (SPS) while decoding a macroblock of a view i when inter-prediction is involved, and passes control to a function block 745. The function block 745 infers a combination of motion information, inter-prediction mode, residual data, disparity data, intra prediction modes, and depth information, and passes control to the function block 770.

The decision block 775 determines whether or not non-anchor_single_loop_decoding is equal to one. If so, then control is passed to a function block 750. Otherwise, control is passed to a function block 760.

The function block 550 considers inter-view dependency from the sequence parameter set (SPS) while decoding a macroblock of view i when no inter-view prediction is involved, and passes control to a function block 755. The function 755 infers a combination of motion information, inter prediction mode, residual data, disparity data, intra prediction modes, and depth information for motion skip macroblocks, and passes control to the function block 770.

The function block 760 considers inter-view dependency from the sequence parameter set (SPS) while decoding a macroblock of view i when inter-prediction is involved, and passes control to a function block 765. The function block 765 infers a combination of motion information, inter prediction mode, residual data, disparity data, intra prediction modes, and depth information, and passes control to the function block 770.

A description will now be given of some of the many attendant advantages/features of the present invention, some of which have been mentioned above. For example, one advantage/feature is an apparatus having an encoder for encoding multi-view video content to enable single loop decoding of the multi-view video content when the multi-view video content is encoded using inter-view prediction.

Another advantage/feature is the apparatus having the encoder as described above, wherein the multi-view video content includes a reference view and other views. The other views are capable of being reconstructed without a complete reconstruction of the reference view.

Yet another advantage/feature is the apparatus having the encoder as described above, wherein the inter-view prediction involves inferring at least one of motion information, inter prediction modes, intra prediction modes, reference indices, residual data, depth information, an illumination compensation offset, a deblocking strength, and disparity data from a reference view of the multi-view video content.

Still another advantage/feature is the apparatus having the encoder as described above, wherein the inter-view prediction involves inferring information for a given view of the multi-view content from characteristics relating to at least one of at least a portion of at least one picture from a reference view of the multi-view video content with respect to the given view, and decoding information relating to the at least a portion of the at least one picture.

Moreover, another advantage/feature is the apparatus having the encoder as described above, wherein a high level syntax element is used to indicate that the single loop decoding is enabled for the multi-view video content.

Further, another advantage/feature is the apparatus having the encoder that uses the high level syntax as described, wherein the high level syntax element one of separately indicates whether the single loop decoding is enabled for anchor pictures and non-anchor pictures in the multi-view video content, indicates on a view basis whether the single loop decoding is enabled, indicates on a sequence basis whether the single loop decoding is enabled, and indicates that the single loop decoding is enabled for only non-anchor pictures in the multi-view video content.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

Furthermore, it is understood that reference to storage media having video signal data encoded thereupon, whether referenced in the specification or claims, includes any type of computer-readable storage medium upon which such data is recorded.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding multi-view video content to enable single loop decoding of the multi-view video content when the multi-view video content is encoded using inter-view prediction.

2. The apparatus of claim 1, wherein the multi-view video content includes a reference view and other views, the other views capable of being reconstructed without a complete reconstruction of the reference view.

3. The apparatus of claim 1, wherein the inter-view prediction involves inferring at least one of motion information, inter prediction modes, intra prediction modes, reference indices, residual data, depth information, an illumination compensation offset, a deblocking strength, and disparity data from a reference view of the multi-view video content.

4. The apparatus of claim 1, wherein the inter-view prediction involves inferring information for a given view of the multi-view content from characteristics relating to at least one of at least a portion of at least one picture from a reference view of the multi-view video content with respect to the given view, and decoding information relating to the at least a portion of the at least one picture.

5. The apparatus of claim 1, wherein a high level syntax element is used to indicate that the single loop decoding is enabled for the multi-view video content.

6. The apparatus of claim 5, wherein the high level syntax element one of separately indicates whether the single loop decoding is enabled for anchor pictures and non-anchor pictures in the multi-view video content, indicates on a view basis whether the single loop decoding is enabled, indicates on a sequence basis whether the single loop decoding is enabled, and indicates that the single loop decoding is enabled for only non-anchor pictures in the multi-view video content.

7. A method, comprising:
encoding multi-view video content to support single loop decoding of the multi-view video content when the multi-view video content is encoded using inter-view prediction.

8. The method of claim 7, wherein the multi-view video content includes a reference view and other views, the other views capable of being reconstructed without a complete reconstruction of the reference view.

9. The method of claim 7, wherein the inter-view prediction involves inferring at least one of motion information, inter prediction modes, intra prediction modes, reference indices, residual data, depth information, an illumination compensation offset, a deblocking strength, and disparity data from a reference view of the multi-view video content.

10. The method of claim 7, wherein the inter-view prediction involves inferring information for a given view of the multi-view content from characteristics relating to at least one of at least a portion of at least one picture from a reference view of the multi-view video content with respect to the given view, and decoding information relating to the at least a portion of the at least one picture.

11. The method of claim 7, wherein a high level syntax element is used to indicate that the single loop decoding is enabled for the multi-view video content.

12. The method of claim 11, wherein the high level syntax element one of separately indicates whether the single loop decoding is enabled for anchor pictures and non-anchor pictures in the multi-view video content, indicates on a view basis whether the single loop decoding is enabled, indicates on a sequence basis whether the single loop decoding is enabled, and indicates that the single loop decoding is enabled for only non-anchor pictures in the multi-view video content.

13. A storage media having video signal data encoded thereupon, comprising:
multi-view video content encoded to support single loop decoding of the multi-view video content when the multi-view video content is encoded using inter-view prediction.

14. The storage media of claim 13, wherein the multi-view video content includes a reference view and other views, the other views capable of being reconstructed without a complete reconstruction of the reference view.

15. The storage media of claim 13, wherein the inter-view prediction involves inferring at least one of motion information, inter prediction modes, intra prediction modes, reference indices, residual data, depth information, an illumination compensation offset, a deblocking strength, and disparity data from a reference view of the multi-view video content.

16. The storage media of claim 13, wherein the inter-view prediction involves inferring information for a given view of the multi-view content from characteristics relating to at least one of at least a portion of at least one picture from a reference view of the multi-view video content with respect to the given view, and decoding information relating to the at least a portion of the at least one picture.

17. The storage media of claim 13, wherein a high level syntax element is used to indicate that the single loop decoding is enabled for the multi-view video content.

18. The storage media of claim 17, wherein the high level syntax element one of separately indicates whether the single loop decoding is enabled for anchor pictures and non-anchor pictures in the multi-view video content, indicates on a view basis whether the single loop decoding is enabled, indicates on a sequence basis whether the single loop decoding is enabled, and indicates that the single loop decoding is enabled for only non-anchor pictures in the multi-view video content.
